(19) United States
(12) Patent Application Publication
(10) Pub. No.: US 2005/0060246 A1
(43) Pub. Date: Mar. 17, 2005

(54) System, method, and computer program product for monitoring inventory

(76) Inventors: Roc Lastinger, Cave Creek, AZ (US); Robert Ufford, Ruswell, GA (US); Nissim Ozer, Las Vegas, NV (US); Armando Edward Viteri, Scottsdale, AZ (US); Kevin Hanson, Phoenix, AZ (US)

Correspondence Address: SQUIRE, SANDERS & DEMPSEY L.L.P.;Two Renaissance Square, Suite 2700, 40 North Central Avenue, Phoenix, AZ, 85004-4498, US

(21) Appl. No.: 10/889,981

(22) Filed: Jul. 12, 2004

Related U.S. Application Data
(60) Provisional application No. 60/486,380, filed on Jul. 11, 2003.
(60) Provisional application No. 60/491,406, filed on Jul. 31, 2003.

(51) Int. Cl. G06F 17/60

(52) U.S. Cl. 705/28

(57) ABSTRACT

A system, method and computer program product are disclosed for monitoring inventory in an inventory control framework. In accordance with one embodiment, information relating to a load supported by a storage unit may be input into the storage unit. The storage unit may have a weight sensor for sensing the weight of the load supported by the storage unit. Information may then be obtained from the storage unit about the load supported by the storage unit as well as information identifying the storage unit. Inventory information relating to the load my be updated based on the information obtained from the storage unit.

### CROSS REFERENCE TO RELATED APPLICATIONS

This application claims the benefit of U.S. Provisional Application No. 60/486,380, filed Jul. 11, 2003. This application also claims the benefit of U.S. Provisional Application No. 60/491,406, filed Jul. 31, 2003.

### TECHNICAL FIELD

Embodiments of the invention may relate to monitoring systems and methods that monitor weight.

### BACKGROUND

In the sales of consumer goods, optical codes (e.g., a barcode) may be applied to each product so that a code reading device may detect the code and access information particular to the product sold. This information may be used, including for a variety of purposes, including proximity (e.g., presence of an object) and inventory control. Retail vending operations may implement such an arrangement when complete packages or containers of products are being sold. However, such an arrangement is typically not very useful in situations where partial contents of a product are being dispensed, for example, describing a number of partial items added to or removed from an inventory.

In inventory management systems that rely on networks for communication to a central computer, frequent additions, removal, and movement of inventory may present a burden to communication and/or increased interference with other systems that use the same network or sensitive electronics. Such networks may include wireless links subject to regulations regarding transmission and interference.

These problems may arise in dispensary, warehouse, and controlled storage applications.

### BRIEF SUMMARY OF THE INVENTION

A system, method, and computer program product are disclosed for monitoring inventory. In accordance with one embodiment, information relating to a load supported by a storage unit may be input into the storage unit. The storage unit may have a weight sensor for sensing the weight of the load supported by the storage unit. Information may be obtained from the storage unit about the load supported by the storage unit as well as information identifying the storage unit. Inventory information relating to the load may be updated based on the information obtained from the storage unit.

In accordance with one implementation of an inventory control system, a storage unit may be adapted for supporting a load. The storage unit may have a weight sensor for sensing the weight of the load supported by the storage unit and an interface for receiving input relating to the load. The storage unit may also have a transmitter for transmitting information about the load including information relating to the weight of the load sensed by the weight sensor. The system may also include a reader adapted for receiving the information transmitted from the storage unit. The system may further include a central controller that may be coupled to the reader and that may update inventory information relating to the load based on the information received by the reader.

In accordance with another implementation, information may be received from a plurality of storage units located in a vehicle. Each storage unit may have at least one weight sensor for sensing the weight of a load supported by the respective storage unit. The information received from each storage unit may relate to the weight of the load supported by the respect storage unit and may also include an unique identifier associated with the respective storage unit. In this implementation, each unique identifier may indicate the location of the respect storage in the vehicle. Based on the information received from the storage units, a current distribution of weight in the vehicle may be determined.

In accordance with a further implementation, the system may comprise a support structure having at least one hanger extending therefrom. The hanger may have an identifier associated therewith and be adapted for supporting a load thereon. In this implementation, a weight sensor may be provided for each hanger to sense a weight of the load supported by the associated hanger. A transmitter may also be provided for transmitting information relating to the weight of the load supported by the hanger as well as the identifier associated with the hanger. A reader may be provided for receiving the information transmitted by the transmitter. In one aspect, the reader may be mounted to the support structure. A central controller may be coupled to the reader to update inventory information relating to the load supported by the hanger based on the information received by the reader.

In accordance with another embodiment, a storage unit includes a user interface, a transmitter, and a weight sensor. The user interface may accept information related to a load supported by the storage unit. The weight sensor may weigh what is currently supported by the storage unit and provide a weight signal to the transmitter. The transmitter may transmit information about the load and identify the storage unit. In one implementation the storage unit includes a processor and memory for instructions executed by the processor. In another implementation, the user interface includes a receiver to receive information regarding the load from the user.

### BRIEF DESCRIPTION OF THE DRAWING

Embodiments of the present invention will be described with reference to the drawing, wherein like numbers refer to like items, comprising:

FIG. 1 is a functional block diagram of an exemplary inventory control system in accordance with an embodiment of the invention;

FIG. 2 is a functional block diagram of an exemplary storage unit in accordance with an embodiment of the invention;

FIG. 3 is a functional block diagram of an exemplary implementation of an inventory control system in a vehicle in accordance with an embodiment of the invention;

FIG. 4 is a functional block diagram of an implementation of an inventory control system incorporated into a presentation structure adapted for presenting items to a user, such as a consumer, in accordance with an embodiment of the invention;

FIG. 5 is a functional representation of an exemplary presentation structure implementation in accordance with an embodiment of the present invention;

FIG. 6 is a flowchart of a process for monitoring inventory in accordance with an embodiment of the present invention;

FIG. 7 is a flowchart of a process for monitoring inventory in accordance with an embodiment of the present invention;

FIG. 8 is a functional block diagram of an illustrative network system with a plurality of components in accordance with an embodiment of the present invention; and

FIG. 9 is a functional block diagram of a representative hardware environment in accordance with an embodiment of the present invention.

### DETAILED DESCRIPTION OF THE INVENTION

An inventory control system according to one embodiment of the invention may include one or more storage units and a reader. The reader may receive information transmitted from a storage unit and may use information preloaded in the storage unit to determine an inventory status. Such information may include, for example: Individual Unit Weight, Max Weight (e.g., full inventory), Min Weight (e.g., reorder or restock inventory). The inventory control system may use this information to, for example, provide an automatic stocking request when the reorder point is reached and real-time reports on inventory status.

Embodiments of the present invention may include a platform (e.g., a mat that may be placed on shelves), a storage rack and/or reusable pallet (e.g., in distribution centers and other locations), collectively referred to as a storage unit. Example applications for the inventory control system may include inventory and product management for warehouse bin/shelf/hanger/pallet storage, raw materials inventory, retail inventory management for products on shelves and hangers, and supply room operations. Storage units may be implemented in bins. Storage units may detect changes in bin weight and report additions, subtractions, and/or attainment of economic order quantity (EOQ). These reports may be useful for vendor-managed inventories. On retail shelves, the storage units may report purchase habits (quantity vs. time-of-day), item turn ratios, pre-event and post-event management (e.g., sales—did they run out of stock and for how long) and to stocking levels.

The weight sensor may be adapted to measure the load on at least a portion of the load supporting surface (e.g., an xy surface area of the storage unit). The weight sensor may output an analog signal (e.g., a voltage) attributed to the load and/or a digital signal that represents the detected load. The reporting system component may comprise a tag having RFID capability. Changes in load (weight) may initiate a transmission from the tag where the tag reports its ID that represents an identifier associated with the storage unit, the load, and a change load indicator. The tag may periodically send an inventory load count (e.g., every hour or at random periods) regardless of load change.

A reader may read signals in any conventional manner sent by each tag or may interrogate tags in any conventional manner, for example, by sending an interrogation signal. Since location information may not be needed, a reader may be able to operate at maximum receiving sensitivity. An area may be served with a minimum (e.g., one) number of readers and a minimum of networking infrastructure between readers and a central database.

Initialization of a storage unit may include weighing an exemplary SKU item, recording in the storage unit a weight for a single item quantity, and recording a weight for a maximum item quantity. The storage unit and/or inventory control system may then map linear weight distribution into item count.

A storage unit operates without a tag on each item. Tags on items (if any) may communicate in any conventional manner.

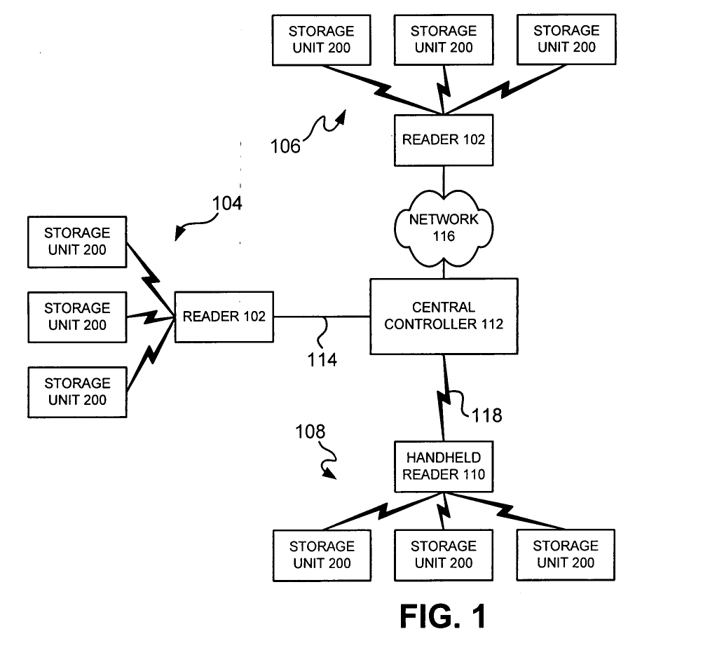

FIG. 1 is a functional block diagram of an exemplary inventory control system 100 in accordance with an embodiment of the invention. The system may include at least one reader 102 capable of wireless communication (i.e., receiving and/or transmitting).

The system 100 may have one or more storage units 200 and at least one reader 102 that may be in wireless communication range with the one or more storage units 200. As shown in FIG. 1, a plurality of adjacent storage units may be grouped together with a corresponding reader (e.g., groups 104, 106, 108), so that wireless communication may occur in each group 104, 106, 108 between each storage unit and the associated reader. In another embodiment, the reader may comprise a portable reader 110, such as for example a portable handheld reader. In a portable handheld reader implementation, the reader may be positionable adjacent a storage unit 200 for affording wireless communication therebetween. In one implementation, the storage units may even be coupled to their associated reader 102 via a wired connection such as a LAN, telephone line (e.g., via modem or DSL) and/or a coaxial cable.

The system 100 may further include a central controller or server 112 that may be in communication with the readers 102, 110 to permit transfer of information between the central controller 112 and the readers 102, 110 and, in an implementation where a reader may be capable of transmitting information to a storage unit 200, between the central controller 112 and a storage unit 200. A reader may be coupled to the central controller either directly (e.g., connection 114), via a network (e.g., network 116) such as, for example, a LAN and/or WAN (e.g., the Internet), and/or via a wireless communication link (e.g., wireless communication link 118) such as for example a Bluetooth communication link and/or WLAN. A reader 102 may be coupled to the central controller 112 via a telephone line or a coaxial cable.

The central controller 112 may implement an inventory control application that provides inventory management tools for the inventory control system 100 and may also provide automated control of product/shelf inventories, timely stocking requests, and product reorders. The central controller 112 may also provide one or more interfaces to standard retail management applications, legacy systems, and/or conventional product distribution networks.

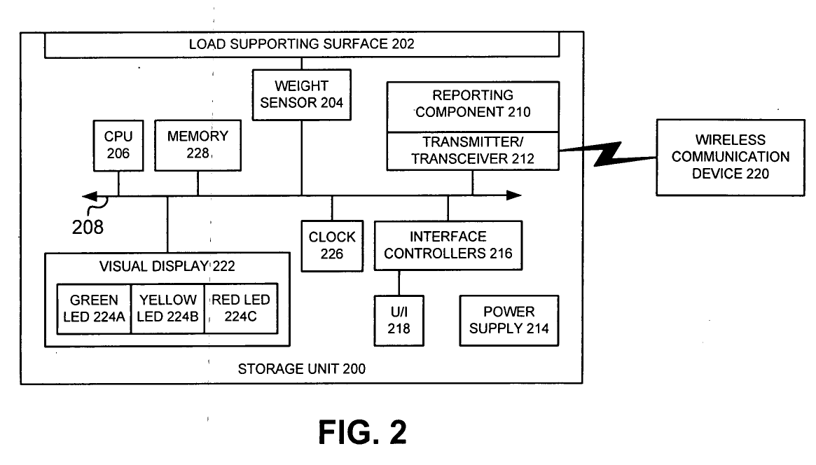

FIG. 2 is a functional block diagram of an exemplary storage unit 200 in accordance with an embodiment of the invention. The storage unit 200 may have a load supporting surface or region 202 for supporting a load (e.g., one or more item(s), objects and/or fluids). In one embodiment, the storage unit 200 may comprise a pad or mat on which items may rest. In such an embodiment, an upper surface of the pad on which the items rest may comprises the load supporting surface 202 of the pad. The upper surface of the pad may be substantially planar. The pad may have a generally rectangular outer perimeter.

The storage unit 200 may comprise a hanger structure upon which items may be hung. A hanger extending from the hanger structure from which the item(s) hang may comprise the load supporting surface 202. In other embodiments, the storage unit 200 may comprise a bin or a container in which one or more items or fluids may be stored. In such embodiments, a lower surface in an interior space of the bin or container may comprise the load supporting surface 202.

The storage unit 200 may also include a weight or load sensor 204 that may be coupled to the load supporting surface 202 for detecting a weight of a load supported on the load supporting surface 202. In one embodiment, the weight sensor 204 may comprise a transducer capable of detecting the weight of the load on the load supporting surface 202 and outputting a signal representative of the weight of the load. In one embodiment, the weight sensor 204 may comprise a piezoelectric weight sensor capable of outputting a signal representative of the weight of the load.

The storage unit 200 may further include a processor 206. The processor 206 may be coupled to the weight sensor 204 for receiving signals from the weight sensor 206 such as, for example, signals representative of the weight of the load supported on the load supporting surface 202. In one embodiment, the weight sensor 204 and the processor 206 may be coupled together via a bus 208 to permit communication over the bus 208.

A reporting system or component 210 may be included in the storage unit 200 for permitting communication to and/or from the storage unit and other devices. In one embodiment, the reporting component 210 may comprise a wireless communication device (i.e., a wireless reporting component) to permit wireless communication of information to and/or from the storage unit 200 and other devices. In one aspect, the wireless reporting component 210 may have a transmitter (e.g., an RF transmitter) for transmitting information from the storage unit 200 to other device(s) in a wireless communication transmission or transmission stream. In another aspect as shown in FIG. 2, the wireless reporting component 210 may have a transceiver 212 (e.g., an RF transceiver) for both transmitting and receiving information to and from the other device(s).

The wireless reporting component 210 may be coupled to the bus 208 so that it may provide and receive information to the other components of the storage unit 200 via the bus 208. For example, the wireless reporting component 210 may receive information via the bus 208 from the processor 206 and/or the weight sensor 204 for inclusion in the information contained in its outgoing wireless transmissions as well as providing the processor 206 and/or weight sensor 204 with information received in incoming wireless transmissions to the wireless communication component 210.

The storage unit 200 may include a power supply 214 for supplying power to the various components of the storage unit. In one embodiment, the power supply 214 may comprise a battery. A battery power supply 214 may be useful in affording additional mobility and portability of the storage unit 200 and permit use of the storage unit in areas where other power supplies are not available.

The storage unit 200 may also include one or more interface controllers 216 (e.g., I/O controllers) coupled to the bus 208 to permit interfacing of the various components of the storage unit to other devices. For example, exemplary interface controllers may include an Ethernet (or other LAN) controller for interfacing with an Ethernet or LAN, a USB controller for interfacing with a USB device, and/or a serial controller for interfacing with devices via a serial port. The interface controllers 216 may permit coupling of one or more user interfaces 218 to the storage unit 200 such as, for example, a keypad, touch pad, mouse and/or other pointing device to permit a user to input information into the components of the storage unit 200. In one aspect, a personal digital assistant (PDA) may be coupled to the storage unit via an interface of one of the interface controllers (e.g., a serial or USB interface) provided on an exterior surface of the storage unit. In another aspect, a wireless communication device 220 (e.g., a wireless PDA or other wireless handheld device) may serve as a user interface to the storage device 200. In such an aspect, the wireless communication device 220 may communicate with the wireless reporting component 212 to input information into the storage unit 200 via a wireless communication to or with the wireless reporting component 212. In an embodiment where a portable handheld reader 110 is provided to load product date into a storage unit 200, the interface controllers 216 of the storage unit 200 may help allow interfacing with a variety of existing handheld reader units.

The storage unit 200 may also have a visual display 222 for presenting visual information, for example to a user of the storage unit. The visual display 222 may be coupled to the bus 208 to permit the visual display 222 to receive and display information from the various components of the storage unit 200. In one embodiment, the visual display may be mounted to an exterior surface of the storage unit. For example, the visual display may be mounted to adjacent the load supporting surface 202 to permit a user to view the visual display while viewing items supported on the load supporting surface 202. In one embodiment, the visual comprise a liquid crystal display (LCD).

The visual display 222 may also comprise one or more warning lights (e.g., warning lights 224a, A1024b, 224c) for providing a visual warning to a user of the storage unit 200. For example, in one embodiment, the warning lights may comprise three warning lights of visibly distinguishable colors so that various information may be ascertained depending on which of the warning lights is illuminated. In one such embodiment, the warning lights may comprise a green-color light emitting warning light 224a, a yellow-color light emitting warning light 224b and a red-color light emitting warning light 224c.

In one embodiment, the storage unit 200 may also include a clock 226 for monitoring the time and/or date. The clock 226 may be coupled to the bus 208 to provide time and date information to the other components of the storage unit 200 as well as to permit control of the clock 226 (including adjustment of the time and/or date) via the user interface(s) 218, 220 and/or by one of the other components of the storage unit 200.

The storage unit 200 may further include a memory 228 for storing information therein. The memory 228 may be coupled to the bus 208 to permit storage and retrieval of information from the memory 228 (i.e., reading and writing to memory) via the bus 208. A variety of information relating to the storage unit 200 and/or a load supported by the storage unit 200 may be stored in the memory. For example, a unique identifier (“STORAGE UNIT ID”) associated with the storage unit 200 may be stored in the memory 228. As another example, the memory may also store information about a unit weight (“LOAD UNIT WEIGHT”) of a load supported on the load supporting surface 202 that represents the weight of one of the items that that comprises the load on the storage unit 200. The memory 228 may also store a maximum load weight (“MAX LOAD WEIGHT. (FULL)”) that represents a maximum load that is to be supported by the storage unit 200 and that may further indicate a weight when a full stock of items are stored on or in the storage unit 200. The memory 228 may also store a minimum load weight (“MIN LOAD WEIGHT (RESTOCK)”) that represents a weight supported by the storage unit 200 at which point a request for restocking items comprising the load may be issued and that may further indicate a weight when a full stock of items are stored on or in the storage unit 200. Date and time information (“DATE/TIME”) may also be stored in the memory 228. The date and time information may include information relating to a date and/or time when a load was first placed on the storage unit 200 (e.g., a stocking date/time), and/or information relating to a date and/or time when a load placed on the storage unit 200 should be removed or restocked (e.g., an expiration date/time).

In use, the information about the load on the storage unit 200 (“load information”) may include current weight and one or more of the unit weight, the maximum load weight, the minimum load weight, and/or the date and time information. Load information may be input into the memory by a user via user interface 218 and/or wireless user interface 220. In another embodiment, the storage unit identifier and/or some or all of the load information may be retrieved from the memory 228 and transmitted to one or more other devices via the reporting component 212.

To provide support for a variety of applications, storage units 200 may be designed in a variety of sizes for various weight categories (e.g., greater than 500 lbs, 50-500 lbs, and 1-50 lbs).

A storage unit 200 may comprise an integrated piezoelectric weight sensor 204, a microprocessor module (with read/write memory), and RF data link. A storage unit 200 may also include a serial interface. The serial interface may be used to down download firmware updates to a storage unit's 200 operating system as well as information about items being supported by the load supporting surface 202 (e.g., product information, unit weight, order point).

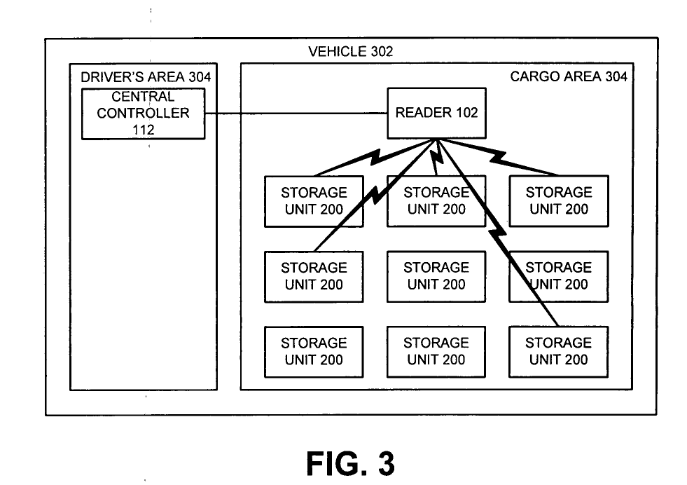

FIG. 3 is a functional block diagram of an exemplary implementation of an inventory control system in a vehicle 300 in accordance with an embodiment of the invention. In this implementation, a plurality of storage units 200 may be arranged in an area 302 of the vehicle 300. For example, as shown in FIG. 3, the storage units 200 may comprise generally rectangular pads laid over a floor 304 of a cargo space 302 of the vehicle 300. One or more readers 102 may be included in the area 302 and in communication range of the storage units 200 in the area 302 so that information may be transmitted between the reader(r) 102 and the storage units 200. The reader(r) 102 may be coupled to a central controller 112. The central controller 112 may be located in the vehicle 300 and as shown in FIG. 3 may be located in a second area 306 of the vehicle such as a passenger or driver's area of the vehicle 300.

Vehicle 300 may comprise an airplane with the first area 302 comprising a cargo hold of the airplane and the second area 306 comprising a cockpit of the airplane. In another implementation, the vehicle 300 may comprise a truck (e.g., a tractor-trailer) with the first area 302 comprising a cargo area (e.g., trailer) of the truck and the second area 306 comprising a cab of the truck. As shown in the implementation depicted in FIG. 3, the storage units may be arranged in the area 302 of the vehicle so that the inventory control system may be used to determine the weight and distribution of the load on the storage units in the vehicle. This information may then be used to determine the overall weight and weight distribution of the entire vehicle (or a portion thereof). This information may be then be used in a variety of applications such as, for example, a determination as to whether the load and/or vehicle is properly balanced.

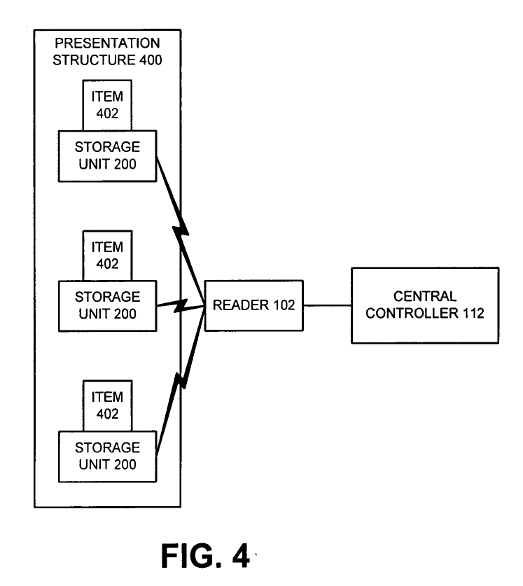

FIG. 4 is a functional block diagram of an implementation of an inventory control system 100 incorporated into a presentation structure 400 adapted for presenting items to a user, such as a consumer, in accordance with an embodiment of the invention. In this implementation, one or more storage units 200 may be mounted to the presentation structure 400 for supporting and displaying items 402. In this implementation, one or more readers 102 may be included internal to the presentation structure 400 (as shown in FIG. 4) or externally. The reader 102 may be coupled a central controller that may also be internal or external (as shown in FIG. 4) to the presentation structure 400.

In a hanger embodiment, a support structure may be provided having at least one hanger extending therefrom. In one implementation, the support structure may be located in a vending machine. The hanger may have an identifier associated therewith and be adapted for supporting a load thereon. In this implementation, a weight sensor may be provided for each hanger to sense a weight of the load supported by the associated hanger. In one implementation, the weight sensor may comprise a piezoelectric weight sensor. In one embodiment, the hanger may have a proximate end coupled to the support structure with a distal end extending away from the support structure. In such an embodiment, the weight sensor may be located adjacent the proximate end of the hanger. A transmitter may also be provided for transmitting information relating to the weight of the load supported by the hanger as well as the identifier associated with the hanger. The transmitter may be part of the tag of the storage unit. In one embodiment, the information relating to the weight of the load supported by the hanger and the identifier of the hanger may be transmitted by the transmitter after the weight sensor senses a change in the weight of the load supported by the hanger. A reader may be provided for receiving the information transmitted by the transmitter. In one aspect, the reader may be mounted to the support structure. A central controller may be coupled to the reader to update inventory information relating to the load supported by the hanger based on the information received by the reader. The central controller may also be coupled to a wide area network.

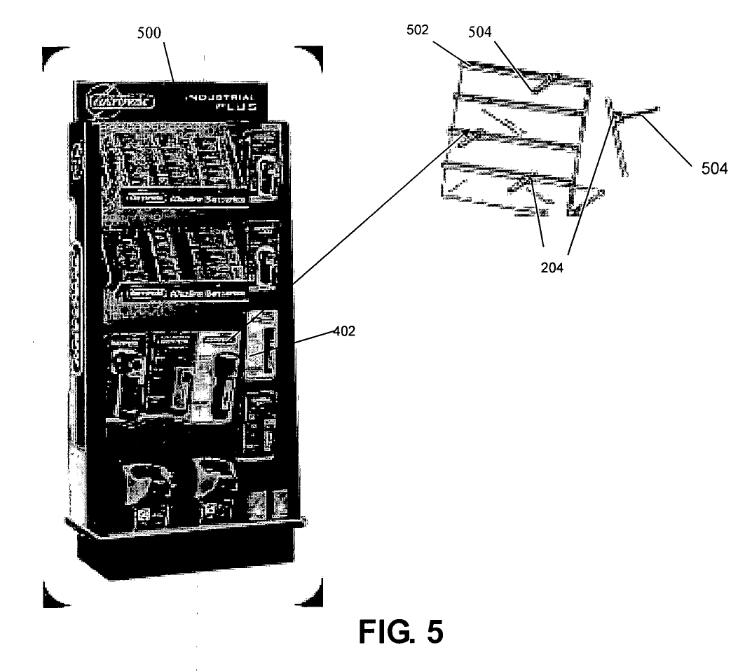

FIG. 5 is a functional representation of an exemplary presentation structure 400 implementation in accordance with an embodiment of the present invention. In this implementation, the presentation structure 400 may comprise a vending machine 500 and a hanger support structure or device 502 from which one or more hangers 504 may extend and on which items 402 may be hung. In such an implementation, the hangers 504 may comprise at least a portion of the load supporting surface 202 of a storage unit 200. The hanger 504 may also include the weight senor 204. In one embodiment, the weight sensor may be located at an end of the hanger 504 which is coupled to the hanger support structure 502 and comprise some sort of cantilevered weight sensor 204 where as weight is hung or removed from the hanger 504, at least a portion of the weight sensor 204 is deflected in a direction when items are added to the hanger 504 (and returned in another direction when items are removed from the hanger). In another embodiment, the weight sensor 204 may comprise a piezoelectric weight sensor located at a pivot point between the hanger 504 and the hanger support structure 502 (e.g., a proximal end of the hanger 504 adjacent the hanger support structure 502 at which the hanger 504 pivots with respect to the hanger support structure 502 when items 402 are added or removed from the hanger 504.

The other components of the storage unit (e.g., the reporting component 210, processor 206, power supply 214) may be included in the hanger 504 and/or the hanger support structure 502. In another embodiment, the other components may be included only in the hanger 504 so that each hanger 504 comprises a storage unit 200. Such an embodiment may be useful for permitting the addition or removal of hangers 504 to the hanger support structure 502 to suit a user's needs or desires or for easier replacement of hangers that are defective, broken, or in need of repair or servicing.

In a hanger implementation, the weight sensor 204 may be used to sense when items are added or removed from the load supporting surface 202. The storage unit 200 may store the information obtained by the sensor regarding the weight and/or change in weight of the load on the load supporting surface 202. The storage unit may also report information relating to the change in load to the central controller 112 via a reader 102.

In one embodiment, the storage unit may be configured to automatically transmit its device ID and revised weight every time there is a change (for example, a product is lifted from a shelf where the storage unit 200 is implemented as a shelf pad or from a hanger. In the implementation shown in FIG. 5, when items are added to or removed from hangers 504, the weight sensor(s) 204 may detect the change in weight and send a signal to a reader 102 that may be located in the hanger 504, hanger support structure 502, and/or the handheld reader 110. In the case where there are multiple hangers 504 on a single hanger support structure 502, it may be possible to provide a single transmitter or transceiver in or on the hanger support structure 502 to establish the requisite wireless link to transmit data from the weight sensors 204 from the individual hangers 504. The hanging sensor may be used for clothes racks, vending machines, and/or other applications where hanging devices may be used.

As previously mentioned, embodiments of the inventory control system 100 may be implemented in a storage area (e.g., a warehouse or distribution area) that includes one or more shelves for storing items thereon. In such an implementation, each shelf may be lined with one or more pad or mat-shaped storage units 200. Pick and place events may be automatically recorded to the central controller 112 in such an implementation. When a desired economic order quantity (EOQ) is reached, a reorder event may be placed either by the storage unit 200 or the central controller 112. This implementation may help enable vendor-managed inventory where the vendor is responsible for inventory maintained on the shelves. Security may be established by embodiments disclosed herein where items taken off the shelves during unauthorized hours would initiate a security alarm event.

Another embodiment of the inventory control system 100 may be utilized to line storage bins or similar storage containers. This implementation may report counting and changes to counts especially in places where barcode scanning is difficult because of height and other limitations. For example, a carpet mill may like to track their bin inventory utilizing the inventory control system 100 because carpet rolls may be very expensive.

In a further implementation, reusable plastic containers/plastic pallets may be lined with storage units. The storage unit would then verify that container/pallet was full during shipping and receiving operations. The totes may often be used in operations like a shelf where they could automatically report stock changes.

In another implementation, a post office letter box may be lined at least in part with a storage unit 200 that may signal when mail was placed in the box. Once mail is placed on a storage unit-lined post office box, a reader 102 may automatically send an email or leave a voice mail indicating that mail had been delivered. Such an implementation may be advantageous because people may not have to waste travel time to their post office boxes to find out that they did not receive any mail.

Another implementation may be carried out with baggage handling carts to help ensure that nothing was added or removed from a baggage handling cart without authorization during baggage handling operations. From a baggage management perspective, items that fall off the cart may be automatically be detect and located.

A further implementation may be afforded in raw inventory staging areas where a floor may be lined with storage units 200 to signal when raw inventory levels were getting low. For instance, when boxes of rations or medical supplies are consumed in a middle-eastern staging area, a military unit could monitor the transaction in real time via a network such as the Internet.

Other exemplary situations where embodiment of the inventory control system may be implemented include monitoring an infant in a bassinette for hospital security, monitory computer and other high-value equipment in an office or lab (e.g., computer set on storage unit—if anyone picks up computer, mat senses absence of load and signals), a patient getting “out of bed” at a hospital, and money stored in a cash register.

In one implementation, the storage unit 200 may automatically record when the weight sensor 204 detects items being added or removed from the load supporting surface 202. In one embodiment, the storage unit 200 may be programmed to automatically transmit its associated identifier (e.g., a storage unit ID) and currently measured or detected weight every time there is a change detected by the weight sensor 204. The central controller 112 may use preloaded product information to automatically determine inventory status. In one aspect the preloaded product information may include unit weight of an item stored on the storage unit 200, maximum weight value that represents the weight of a full complement of items supported on the storage unit 200 (“Max Weight—Full”) and minimum weight value that represents the weight of a number of items supported on the storage unit 200 which is less than a full complement of items and that indicates that the storage unit 200 should be restocked with more items (“Min Weight—Reorder”). In one embodiment, the central controller may use this information to provide an automatic stocking request when the reorder point is reached and real-time reports on inventory status. In another embodiment, the preloaded product information may be stored in the storage unit 200. In such an embodiment, the storage unit 200 may use this information to initiate provide an automatic stocking request when the reorder point is reached and real-time reports on inventory status.

The storage unit 200 may be battery-powered with an integrated wireless reporting system 210. As a result, the storage unit 200 may not require custom wiring or other special installation. The storage unit's wireless link 210 may be used to automatically provide a central reader 102 with the real-time status of the storage unit 200.

The weight sensor may be coupled to the transmitter and/or a processor in any conventional manner. For example, one or more sensors may be formed in a grid juxtaposed to the support surface discussed above. A processor may determine the strain on any weight sensor in the grid, determine the position of the mass causing the strain, and form a report to be transmitted. A weight sensor and/or detector may be integrated on the same substrate as the tag (e.g., the same substrate as a processor and/or a transmitter).

The storage unit 200 and inventory system 100 may be utilized in warehouse bin/shelf storage, raw materials inventory, retain shelf management, and supply room operations. In such applications, storage units 200 may be placed in each bin and programmed fore the weight of measure. The storage units 200 may then stand watch to report additions/subtractions or attainment of economic order quantity (EOQ). Storage units 200 on retail shelves may be utilized to report purchase habits (e.g., quantity vs. time-of-day), item turn ratios, pre-event and post-event management (e.g. sales issues such as—“Did they run out of stock and for how long/”) and/or stockage levels. Where items where shelf life may be important, a storage unit 200 may be used to stand watch for minimum and/or maximum times (e.g., expiration times). In the flooring industry for example, items may have to sit on a shelf for a minimum number of days to cure before processing. Conversely, perishable items may not be able to remain on a shelf beyond a specified time.

Embodiments of the storage units 200 and the inventory control system 100 may be utilized in pick and place management applications. For example, forklift (FLT) operations may be subject to human error when inventory is placed or pulled from the wrong shelf. Losses/down time from misplaced inventory may disruptive and costly to plant operations so that utilization of the storage units 200 and the inventory control system 100.

In yet another aspect, the storage unit 200 and the inventory control system 100 may be utilized in security applications. For example, a storage unit 200 may be programmed to set off security notifications if items are pulled during hours when no activity should occur.

In accordance with embodiments of the present invention, a plurality of exemplary implementations will now be discussed in further detail. In one exemplary implementation, a storage unit 200 may comprise a pad with embedded weight sensor, a microprocessor and memory section that provides control over system operation and data transfer, an IO section that provides a wired interface to an existing network or a serial or USB interface, and an RF Transmitter for relaying pad/weight status to a central monitor. In such an embodiment, the storage unit 200 may be configured in a range of sizes. For example, the storage unit 200 may be shaped in a generally rectangular pad designed to fit standard shelving sizes for warehouses, retail stores, commercial refrigeration units, and so on. In one configuration, the radio transmitter in the storage unit 200 may have a range between approximately about 200 and about 300 feet. A shelving system may be divided into areas for different products. In such an implementation, each product area may be equipped with a storage unit 200.

The storage unit 200 may be programmed with a unique ID and to automatically report any changes in weight via the RF link 210 to a centrally located reader/receiver 102. One or more readers may be configured to provide coverage for a designated area (e.g., as shown in FIG. 1). The reader 102 may have an embedded control unit that is used to receive and process data from the storage unit(s) 200 or the readers can be connected to a central controller/server 112 as shown in FIG. 1. The readers may also be connected via a standard Ethernet network or wireless LAN (WLAN). The central controller 112 may be programmed with characteristics for the products that are placed on each shelf such as, for example: unit weight, minimum stocking weight, and re-order weight. The central controller 112 may use the product data to provide real-time inventory status for items located on the shelves.

In another exemplary implementation, the radio section 210 of the storage unit may be configured as a transceiver to help afford two-way communications between the storage unit and the reader 102. In this embodiment, the reader may contain an embedded control unit or a network of readers may be connected to a central controller 112 via a LAN or WLAN connections. In one embodiment, the reader 102 may download the product weight data to the storage unit 200. In such an embodiment, the microprocessor 206 in the storage unit 200 may monitor the weight of the product and automatically reports product statistics such as predetermined weight/inventory levels. This aspect of the present invention may be useful in situation where data communications between the storage unit 200 and a reader 102 need to be reduced and/or kept-at a minimum. For example, if the storage unit 200 is battery powered, such operation may help reduce battery consumption and extend battery life. As another example, in applications with a large number of storage units 200, the number of data transactions may be minimized while distributing data processing functions over the system. As a further example, the two-way communications may help to provide a method for confirming data transmission and receipt by the reader.

A transceiver system may be configured to operate on one or more different frequencies at variety of frequencies and communications protocols. Examples include, but are not limited to: 802.11b, 802.11a, 802.11g, 900 MHz (Manchester Encoding), and 300 MHz (Manchester Encoding). In a warehouse environment, there may be a variety of obstructions between a storage unit 200 and a reader 102. The penetration and scatter characteristics of lower frequencies (300-900 MHz) may be better suited for such an environment. In a typical application, the data rates from the storage unit 200 to reader 102 may be relatively low. Such limited data rates may help support operation at lower frequencies (e.g., 300-900 MHz).

In a further exemplary implementation, a handheld reader 110 may be utilized to collect and transmit information to a storage unit 200. Such an aspect may be useful in transport related applications. For example, in a trucking application, a handheld reader 110 may be used to record the status (weight) of each pallet as it is removed from a truck. In such an implementation, the handheld reader 110 may be equipped with a transceiver that may be used to query the status of a storage unit 200.

The read/query range of the reader 110 may also be adjustable so that the reader 110 can be tailored for specific applications. For example, in a warehouse application, the range of the reader 110 may be expanded to provide rapid inventory for a large area. Conversely, in an application where a handheld reader 110 is used to record pallets as they are moved through a door or a control, the read range may be reduced to a more limited area.

In one specific implementation, air cargo containers, pallets, and other shipping containers may be equipped with storage units 200. A handheld reader may be used in such an implementation to query the status of each storage unit as the transport container is loaded on an aircraft. As another option, the floor of the cargo area of the aircraft may be equipped with storage units 200 so that a handheld reader 110 (and/or a reader 102 centrally located in the aircraft) may be used to query the status of each storage unit 200 and determine an accurate weight and balance configuration for the aircraft.

In yet another exemplary implementation, a storage unit 200 may include a visual indicator such as a visual display 222. For example, a storage unit 200 may include a LCD display, LED/light read outs that indicate weight/stock levels, and/or a red-yellow-green warning lights system (e.g., colored LEDs). The local display may be used in combination with the previous embodiments of the inventor control system or as a standalone system. In one implementation, a storage unit 200 may be loaded (wired and/or wireless) with the weight/stock data for the product or products that are to be stored on the load supporting surface 202. In one embodiment, the display may be used to display the current inventory of the product based on the information obtained by the weight sensor and the processor of the storage unit. Other information may also be displayed on the display 222 such as, for example: the weight of an item on the storage unit; a total weight stored on the storage unit; a percent of the inventory of an item remaining on the storage unit 200; a number of items currently stored on the storage unit 200; a maximum number of items that may be stored on the storage unit 200; and/or the number of items initially stocked on the storage unit 200. The method for selecting the display of the product status information may be dependent of the particular application being implemented (e.g., a shelf, pallet, or floor area implementation) and/or the number of products stored in a given area.

In yet a further exemplary implementation of the inventory control system 100, a storage unit 200 may be utilized as a security system. In such an aspect, a designated area may be covered with storage units 200. Some exemplary designated areas may include a shelf, a pallet, a floor area, a cargo area, and/or an entrance/exit area. In one implementation, the storage unit 200 may be programmed in two modes: a first mode where the storage unit 200 is programmed to detect the addition of weight to the load supporting surface 202 and a second mode where the storage unit 200 is programmed to detect when weight is removed from the load supporting surface 202.

The first mode of operation may be used to detect the intrusion into an area covered by a storage unit 200. For example, a storage unit 200 placed at an entrance to a building may be utilized to wirelessly alert a central controller 112 of traffic through the entrance. In one implementation, the storage unit 200 may be programmed with various weight thresholds depending on the application. For example, a storage unit 200 may be set to ignore the weight of an individual, but to alarm (transmit) when a vehicle pass through a designated area.

In the second mode of operation, a storage unit 200 may would be programmed with a minimum weight threshold. If items are removed from load supporting surface A102 of the storage unit 200, the storage unit 200 may relay a wireless alert to a remote reader 102/central controller 112. The storage unit 200 and/or the central controller 112 may be programmed with a series of thresholds both weight and time to determine when an alert should be activated.

These security embodiments may be useful in a broad range of applications. In addition to security alerts, a storage unit 200 may be used to detect and report overload conditions for pallets, shelving, decks, and other areas that may have weight/loading restrictions.

An advantage of embodiments of the storage unit 200 and inventory control system 100 may be that the storage unit 200 may be quickly position in a required area to provides real-time wireless data on the weight/status in the given area. Another advantage may be that the number and frequency of radio transmissions between storage units and a reader may be reduced to help reduce the overall radio noise of an area. Battery power consumption may also be reduced by reducing the number and frequency of radio transmissions between storage units and a reader.

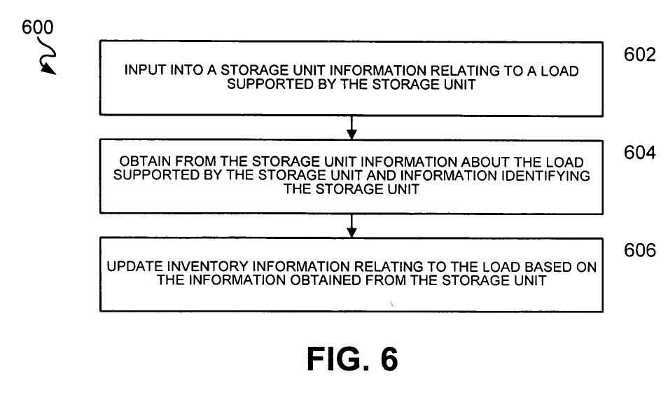

In accordance with the previously discussed embodiments and implementations, FIG. 6 is a flowchart of a process 600 for monitoring inventory in accordance with an embodiment of the present invention. In operation 602 information relating to a load supported by a storage unit may be input into the storage unit. The storage unit may include a weight sensor for sensing the weight of the load supported by the storage unit. In operation 604, information may be obtained from the storage unit about the load supported by the storage unit as well as information identifying the storage unit. In operation 606, inventory information relating to the load may be updated based on the information obtained from the storage unit.

The storage unit may also have an interface for receiving input relating to the load. In one embodiment, a reader may be provided that is adapted for receiving the information transmitted from the storage unit. A central controller may also be provided that is coupled to the reader. The central controller may update the inventory information relating to the load based on the information received by the reader.

In one embodiment, the load supported by the storage unit may comprise one or more items and the information input into the storage unit may include information about a unit weight of a single item of the load. In such an embodiment, the storage unit may determine a number of items that comprise the load based on the information about the unit weight of the single item and the weight of the load sensed by the weight sensor. The information obtained about the load supported by the storage unit may also include the determined number of items that comprises the load. After the weight sensor senses a change in the weight of the load supported by the storage unit, the storage unit may also update the information about the number of items comprising the load to reflect the sensed change in weight (i.e., the storage unit may determine an updated number of items that comprise the load based on the new weight sensed by the weight sensor and the unit weight).

In one embodiment, the information input into the storage unit may include information about a maximum number of items to be supported by the storage unit so that the information obtained from the storage unit may also include the information about the maximum number of items.

The information input into the storage unit may include information about a minimum number of items to be supported by the storage unit. After the weight sensor senses the weight of the load to be at most equal to a weight for the minimum number of items, the information obtained from the storage unit may further include a notice to restock the load supported by the storage unit. After receipt of the notice, a message may be sent to a supplier of the items as a further option. In such an embodiment, the central controller may be adapted for sending (after receipt of the notice by the reader) an order for additional items to a supplier of the items.

The message may be sent to the supplier via a network such as the Internet. Such a message may include an order for additional items for restocking the load supported by the storage unit. The message may also identify: the number of additional items being ordered, the number of additional items being provided by the storage unit based on a determination utilizing at least one of the unit weight of a single item of the load, the minimum number of items to be supported by the storage unit, a maximum number of items to be supported by the storage unit, a maximum load weight to be supported by the storage unit, and/or a minimum load weight to be supported by the storage unit.

In one embodiment, the information input into the storage unit may include information about a maximum load weight of a load to be supported by the storage unit. In such an embodiment, the information about the maximum load unit weight may be included in the information obtained from the storage unit. In another embodiment, the information input into the storage unit may include information about a minimum load weight of a load to be supported by the storage unit. In such an embodiment, the information about the minimum load unit weight may be included in the information obtained from the storage unit. In a further embodiment, the information identifying the storage unit may comprise a unique identifier associated with the storage unit.

In-one embodiment, the storage unit may includes a wireless transmitter for transmitting the information about the load obtained from the storage unit. The storage unit may include a radio frequency identification (RFID) tag for transmitting the information about the load obtained from the storage unit. In one implementation, the information obtained from the storage unit may be received in a transmission initiated by the storage unit. In another implementation, the information obtained from the storage unit may be received from the storage unit in response to a query. This query may be sent to the storage unit via a wireless transmission from an radio frequency (RF) reader device which may comprise a portable handheld device.

In one aspect, the storage unit may have a receiver or a transceiver for receiving information from the reader. In another aspect, information communicated between the transmitter of the storage unit and the reader may be performed via a wireless communication link. In one embodiment, the central controller may be coupled to the reader via a wireless communication link. In another embodiment, the central controller may be coupled to a wide area network. While an RF link may be used to relay information to and from a storage unit to a reader and/or central controller, embodiments may be carried out using infrared, ultrasonic, and/or cellular wireless communication devices. A storage unit may also be connected to a central controller via standard wired connections including, for example, Ethernet, telephone, and cable. In one embodiment, a network of readers in the system may be connected via a LAN/WLAN connections. Like the storage unit, a reader may be connected via a variety of standard data communications systems.

In one embodiment, the storage unit may include a visual display for visually displaying information about the load supported by the storage unit. The visual display may include one or more visual indicators for indicating a current status of the load supported by the storage unit. In one aspect, the visual indicators may include at least one of: a first indicator (such as, e.g., a green colored LED) for indicating that an amount of items comprising the load supported by the storage unit is sufficient (for supply and inventory purposes), a second indicator (such as, e.g., a yellow colored LED) for indicating that the load supported by the storage unit needs to be re-supplied with additional items, and/or a third indicator (such as, e.g., a red colored LED) for indicating that the load supported by the storage unit is to be replaced (for instance, the items comprising the load are past their expiration date or that the original load has been removed from the storage unit thereby leaving the storage unit empty (i.e., not currently supporting a load)).

In one embodiment, the storage unit may be located in a vehicle. In one implementation, the vehicle may comprise an airplane. In another implementation, the vehicle may comprise a ground vehicle such as a van, a truck, or a train. In such an embodiment, the information obtained from the storage unit about the load supported by the storage unit may be utilized to determine an overall weight of the vehicle. The information obtained from the storage unit about the load supported by the storage unit may be utilized to determine a distribution of weight in the vehicle (i.e., a weight distribution of the vehicle). The load supported by the storage unit may then be adjusted (to either add or remove items comprising the load) based on the determined distribution of weight in the vehicle.

In one embodiment, the storage unit may have a hanger for supporting the load therefrom. The storage unit may also have a structure for supporting the hanger above a ground surface so that at least a portion of the load supported by the hanger may be suspended from the hanger above the ground surface. In one implementation, the storage unit may be located in a vending machine.

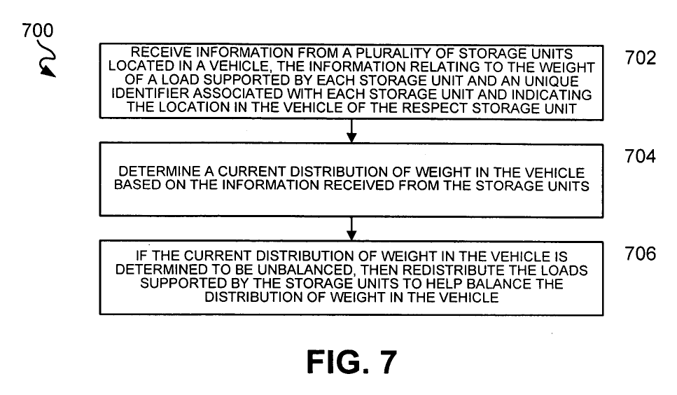

FIG. 7 is a flowchart of a process 702 for monitoring inventory in accordance with an embodiment of the present invention. In operation 702, information may be received from a plurality of storage units located in a vehicle. The storage units may each have at least one weight sensor for sensing the weight of a load supported by the respective storage unit. The information from each storage unit may relate to the weight of the load supported by the respect storage unit and may include an unique identifier associated with the respective storage unit. Each unique identifier may also indicate the location in the vehicle of the respect storage. In operation 704, a current distribution of weight in the vehicle may be determined based on the information received from the storage units. In operation 706, if the current distribution of weight in the vehicle is determined to be unbalanced, the loads supported by the storage units may be redistributed to help balance the distribution of weight in the vehicle.

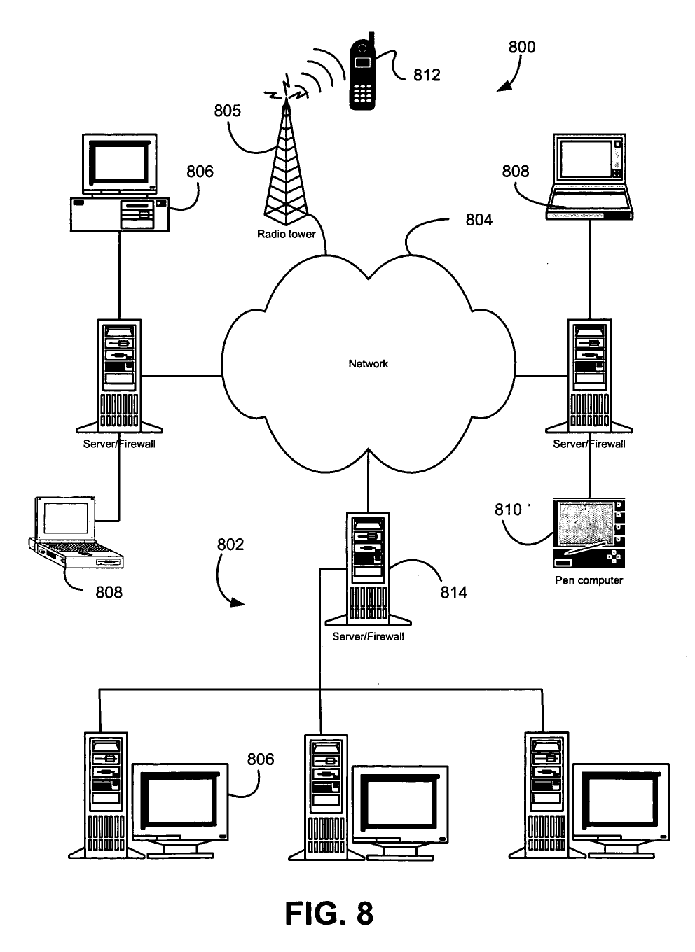

FIG. 8 illustrates an exemplary network system 800 with a plurality of components 802 in accordance with one embodiment of the present invention. As shown, such components include a network 804 which take any form including, but not limited to a local area network, a wide area network such as the Internet, and a wireless network 805. Coupled to the network 804 is a plurality of computers which may take the form of desktop computers 806, lap-top computers 808, hand-held computers 810 (including wireless devices 812 such as wireless PDA's or mobile phones), or any other type of computing hardware/software. As an option, the various computers may be connected to the network 804 by way of a server 814 which may be equipped with a firewall for security purposes. It should be noted that any other type of hardware or software may be included in the system and be considered a component thereof.

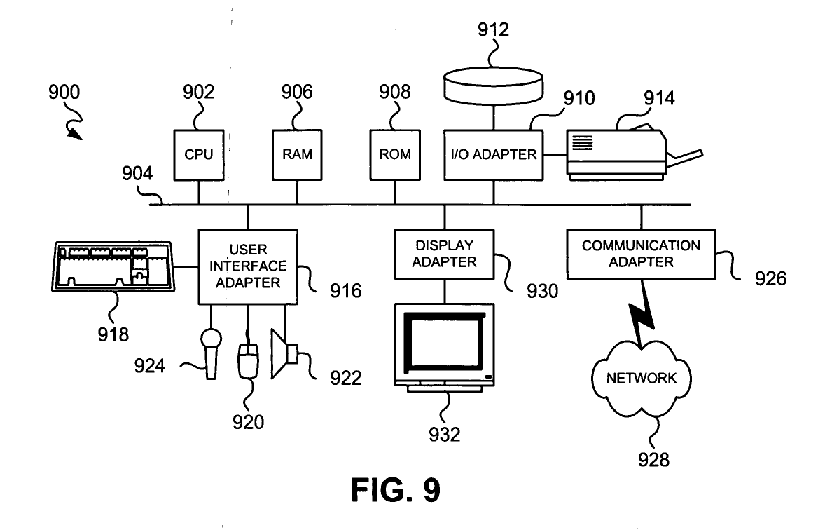

A representative hardware environment associated with the various components of FIG. 8 is depicted in FIG. 9. In the present description, the various sub-components of each of the components may also be considered components of the system. For example, particular software modules executed on any component of the system may also be considered components of the system. In particular, FIG. 9 illustrates an exemplary hardware configuration of a workstation 900 having a central processing unit 902, such as a microprocessor, and a number of other units interconnected via a system bus 904.

The workstation shown in FIG. 9 includes a Random Access Memory (RAM) 906, Read Only Memory (ROM) 908, an I/O adapter 910 for connecting peripheral devices such as, for example, disk storage units 912 and printers 914 to the bus 904, a user interface adapter 916 for connecting various user interface devices such as, for example, a keyboard 918, a mouse 920, a speaker 922, a microphone 924, and/or other user interface devices such as a touch screen or a digital camera to the bus 904, a communication adapter 926 for connecting the workstation 900 to a communication network 928 (e.g., a data processing network) and a display adapter 930 for connecting the bus 904 to a display device 932. The workstation may utilize an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned. An embodiment of the present invention may also be written using Java, C, and the C++ language and may utilize object oriented programming methodology.

Transmission Control Protocol/Internet Protocol (TCP/IP) is a basic communication language or protocol of the Internet. It may also be used as a communications protocol in the private networks called intranet and in extranet. TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination. TCP/IP may use a client/server model of communication in which a computer user (a client) requests and is provided a service (such as sending a Web page) by another computer (a server) in the network. TCP/IP and the higher-level applications that use it may be considered “stateless” because each client request is considered a new request unrelated to any previous one (unlike ordinary phone conversations that require a dedicated connection for the call duration). Being stateless frees network paths so that everyone can use them continuously. Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Wireless may refer to a communications, monitoring, or control system in which electromagnetic radiation spectrum or acoustic waves carry a signal through atmospheric space rather than along a wire. In wireless systems, radio frequency (RF) or infrared transmission (IR) waves may be used. Common examples of wireless equipment in use today include the Global Positioning System (GPS), cellular telephone phones and pagers, cordless computer accessories and wireless LAN (WLAN). Wi-Fi (short for “wireless fidelity”) is a high-frequency wireless local area network (WLAN). Wi-Fi is specified in the 802.11b specification from the Institute of Electrical and Electronics Engineers (IEEE) and is part of a series of wireless specifications together with 802.11, 802.11a, and 802.11g. All four standards use the Ethernet protocol and CSMA/CA (carrier sense multiple access with collision avoidance) for path sharing.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special-purpose computer hardware to create a computer system or computer sub-system embodying the method of the invention. While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

1. A method, comprising:
inputting into a storage unit information relating to a load supported by the storage unit, the storage unit having a weight sensor for sensing the weight of the load supported by the storage unit;
obtaining from the storage unit information about the load supported by the storage unit and information identifying the storage unit; and
updating inventory information relating to the load based on the information obtained from the storage unit

2. The method of claim 1, wherein the load supported by the storage unit comprises one or more items, and wherein the information input into the storage unit includes information about a unit weight of a single item of the load.

3. The method of claim 2, wherein the storage unit determines a number of items that comprises the load based on the information about the unit weight of the single item and the weight of the load sensed by the weight sensor.

4. The method of claim 3, wherein the information obtained about the load supported by the storage unit includes the determined number of items that comprises the load.

5. The method of claim 4, wherein after the weight sensor senses a change in the weight of the load supported by the storage unit, the storage unit updates the information about the number of items comprising the load to reflect the sensed change in weight.

6. The method of claim 2, wherein the information input into the storage unit includes information about a maximum number of items to be supported by the storage unit, and wherein the information about the maximum number of items is included in the information obtained from the storage unit.

7. The method of claim 2, wherein the information input into the storage unit includes information about a minimum number of items to be supported by the storage unit, and wherein the information obtained from the storage unit includes a notice to restock the load supported by the storage unit after the weight sensor senses the weight of the load to be at most equal to a weight for the minimum number of items.

8. The method of claim 7, wherein a message is sent to a supplier of the items after receipt of the notice to restock the load supported by the storage unit.

9. The method of claim 8, wherein the message includes an order for additional items for restocking the load supported by the storage unit.

10. The method of claim 9, wherein the message identifies the number of additional items being ordered, the number of additional items being provided by the storage unit based on a determination utilizing at least one of the unit weight of a single item of the load, the minimum number of items to be supported by the storage unit, a maximum number of items to be supported by the storage unit, a maximum load weight to be supported by the storage unit, and a minimum load weight to be supported by the storage unit.

11. The method of claim 8, wherein the message is sent to the supplier via a network.

12. The method of claim 1, wherein the information input into the storage unit includes information about a maximum load weight of a load to be supported by the storage unit, and wherein the information about the maximum load unit weight is included in the information obtained from the storage unit.

13. The method of claim 1, wherein the information input into the storage unit includes information about a minimum load weight of a load to be supported by the storage unit, and wherein the information about the minimum load unit weight is included in the information obtained from the storage unit.

14. The method of claim 1, wherein the information identifying the storage unit comprises a unique identifier associated with the storage unit.

15. The method of claim 1, wherein the storage unit includes a wireless transmitter for transmitting the information about the load obtained from the storage unit.

16. The method of claim 1, wherein the storage unit includes a radio frequency identification (RFID) tag for-transmitting the information about-the load-obtained from the storage unit.

17. The method of claim 1, wherein information obtained from the storage unit is received in a transmission initiated by the storage unit.

18. The method of claim 1, wherein information obtained from the storage unit is received from the storage unit in response to a query.

19. The method of claim 18, wherein the query is sent to the storage unit via a wireless transmission from an radio frequency device.

20. The method of claim 19, wherein the radio frequency device comprises a portable handheld device.

21. The method of claim 1, wherein the storage unit includes a visual display for visually displaying information about the load supported by the storage unit.

22. The method of claim 21, wherein the visual display includes one or more visual indicators for indicating a current status of the load supported by the storage unit.

23. The method of claim 22, wherein the visual indicators includes at least one of: a first indicator for indicating that an amount of items comprising the load supported by the storage unit is sufficient (for supply and inventory purposes), a second indicator for indicating that the load supported by the storage unit needs to be re-supplied with additional items, and a third indicator for indicating that the load supported by the storage unit is to be replaced.

24. The method of claim 1, wherein the storage unit is located in a vehicle.

25. The method of claim 24, wherein the information obtained from the storage unit about the load supported by the storage unit is utilized to determine an overall weight of the vehicle.

26. The method of claim 24, wherein the information obtained from the storage unit about the load supported by the storage unit is utilized to determine a distribution of weight in the vehicle.

27. The method of claim 26, wherein the load supported by the storage unit is adjusted based on the determined distribution of weight in the vehicle.

28. The method of claim 1, wherein the storage unit has a hanger for supporting the load therefrom.

29. The method of claim 28, wherein the storage unit has a structure for supporting the hanger above a ground surface.

30. The method of claim 1, wherein the storage unit is located in a vending machine.

31. A system, comprising:
logic for inputting into a storage unit information relating to a load supported by the storage unit, the storage unit having a weight sensor for sensing the weight of the load supported by the storage unit;
logic for obtaining from the storage unit information about the load supported by the storage unit and information identifying the storage unit; and
logic for updating inventory information relating to the load based on the information obtained from the storage unit.

32. A computer program product, comprising:
computer code for inputting into a storage unit information relating to a load supported by the storage unit, the storage unit having a weight sensor for sensing the weight of the load supported by the storage unit;
computer code for obtaining from the storage unit information about the load supported by the storage unit and information identifying the storage unit; and
computer code for updating inventory information relating to the load based on the information obtained from the storage unit.

33. A system, comprising:
a storage unit for supporting a load, the storage unit having a weight sensor for sensing the weight of the load interface for receiving input relating to the load, the storage unit having a transmitter for transmitting information about the load including information relating to the weight of the load sensed by the weight sensor;
a reader for receiving the information transmitted from the storage unit; and
a central controller coupled to the reader, the central controller updating inventory information relating to the load based on the information received by the reader.

34. The system of claim 33, wherein the storage unit has a receiver for receiving information from the reader.

35. The system of claim 33, wherein information communicated between the transmitter of the storage unit and the reader is performed via a wireless communication link.

36. The system of claim 33, wherein the storage unit has a unique identifier associated therewith, the unique identifier being included in the information transmitted from transmitter of the storage unit.

37. The system of claim 33, wherein the load supported by the storage unit comprises one or more items, and wherein input received via the interface of the storage unit includes information about a unit weight of a single item of the load.

38. The system of claim 37, wherein the storage unit determines a number of items that comprises the load based on the information about the unit weight of the single item and the weight of the load sensed by the weight sensor.

39. The system of claim 33, wherein the central controller is coupled to the reader via a wireless communication link.

40. The system of claim 33, wherein the central controller is coupled to a wide area network.

41. The system of claim 33, wherein the input received from the interface includes information about a minimum number of items to be supported by the storage unit, and wherein the information transmitted from the storage unit to includes a notice to restock the load supported by the storage unit after the weight sensor senses the weight of the load to be at most equal to a weight for the minimum number of items.

42. The system of claim 41, wherein the central controller is adapted for sending, after receipt of the notice by the reader, an order for additional items to a supplier of the items.

43. The system of claim 33, wherein the transmitter comprises a radio frequency identification (RFID) tag.

44. The system of claim 33, wherein the reader comprises a portable handheld device.

45. The system of claim 33, wherein the storage unit has a visual display for visually displaying information about the load supported by the storage unit.

46. The system of claim 45, wherein the visual display includes one or more visual indicators for indicating a current status of the load supported by the storage unit.

47. The system of claim 33, wherein the storage unit is located in a vehicle.

48. The system of claim 33, wherein the storage unit has a hanger for supporting the load therefrom.

49. The system of claim 48, wherein the storage unit has a structure for supporting the hanger above a ground surface.

50. A method, comprising:
receiving information from a plurality of storage units located in a vehicle, the storage units each having at least one weight sensor for sensing the weight of a load supported by the respective storage unit, the information from each storage unit relating to the weight of the load supported by the respect storage unit and an unique identifier associated with the respective storage unit, each unique identifier indicating the location in the vehicle of the respect storage unit;
determining a current distribution of weight in the vehicle based on the information received from the storage units.

51. The method of claim 50, wherein if the current distribution of weight in the vehicle is determined to be unbalanced, redistributing the loads supported by the storage units to help balance the distribution of weight in the vehicle.

52. A system, comprising:
a vehicle;
a plurality of storage units located in a vehicle, each storage unit supporting a load and having a weight sensor for sensing the weight of the respective supported load and a transmitter for transmitting information relating to the sensed weight of the load, the transmitted information further including an identifier associated with the respective storage unit, each identifier indicating a location of the respective storage unit in the vehicle;
logic for receiving the information transmitted from storage units; and
logic for determining a current distribution of weight in the vehicle based on the information received from storage units.

53. The system of claim 52, further comprising logic for issuing a notice to redistribute the loads supported by the storage units if the current distribution of weight in the vehicle is determined to be unbalanced.

54. The system of claim 52, wherein the vehicle comprises an airplane.

55. A system, comprising:
a support structure having at least one hanger extending therefrom, the hanger having an identifier associated therewith and being adapted for supporting a load thereon;
a weight sensor for sensing a weight of the load supported by the hanger;
a transmitter for transmitting information relating to the weight of the load supported by the hanger and the identifier of the hanger;
a reader for receiving the information transmitted by the transmitter; and
a central controller coupled to the reader, the central controller updating inventory information relating to the load supported by the hanger based on the information received by the reader.

56. The system of claim 55, wherein the support structure is located in a vending machine.

57. The system of claim 55, wherein the transmitter comprises a radio frequency identification (RFID) tag.

58. The system of claim 55, wherein the reader is mounted to the support structure.

59. The system of claim 55, wherein the information relating to the weight of the load supported by the hanger and the identifier of the hanger is transmitted by the transmitter after the weight sensor senses a change in the weight of the load supported by the hanger.

60. The system of claim 55, wherein the central controller is coupled to a wide area network.

61. The system of claim 55, wherein the weight sensor comprises a piezoelectric weight sensor.

62. The system of claim 55, wherein the hanger has a proximate end coupled to the support structure and a distal end extending away from the support structure, wherein the weight sensor is located adjacent the proximate end of the hanger.

63. A device comprising:
a surface adapted for supporting a load thereon;
a weight sensor for sensing a weight of the load supported on the surface;
an interface for receiving input relating to the load; and
a transmitter for transmitting information in accordance with the weight and the input received by the interface, the transmitted information including an identifier associated with the device.

64. The device of claim 63, wherein the load supported by the storage unit comprises one or more items, and wherein the input received by the interface includes information about a unit weight of a single item of the load.

65. The device of claim 64, further comprising logic for determining a number of items that comprises the load based on the information about the unit weight of the single item and the weight of the load sensed by the weight sensor.

66. The device of claim 65, wherein the transmitted information includes the determined number of items that comprise the load.

67. The device of claim 63, wherein the transmitter transmits the information about the load after the weight sensor senses a change in the weight of the load supported by the surface.

68. The device of claim 63, wherein the input received by the interface includes information about a maximum number of items to be supported by the surface.

69. The device of claim 63, wherein the input received by the interface includes information about a minimum number of items to be supported by the surface, and wherein the information transmitted by the transmitter includes a notice to restock the load after the weight sensor senses the weight of the load to be at most equal to a weight for the minimum number of items.

70. The device of claim 63, further comprising a visual display for visually displaying information about the load based on the weight sensed by the weight sensor and the input received by the interface.

71. The device of claim 63, wherein the visual display includes one or more visual indicators for indicating a current status of the load supported by the surface.
